(19) United States
(12) Patent Application Publication
(10) Pub. No.: US 2019/0197647 A1
(43) Pub. Date: Jun. 27, 2019

(54) Dispatching Systems and Related Methods

(71) Applicant: James Eric Battleson, White Marsh, MD (US)

(72) Inventor: James Eric Battleson, White Marsh, MD (US)

(21) Appl. No.: 15/855,972

(22) Filed: Dec. 27, 2017

(51) Int. Cl. G06Q 50/30; G06Q 10/10; G06Q 40/08; G06Q 10/06

(52) U.S. Cl. CPC G06Q 50/30; G06Q 10/063116; G06Q 40/08; G06Q 10/10

(57) ABSTRACT

Dispatching systems include user interfaces displayed on computing devices communicatively coupled with a server coupled with a database, including a first computing device (administrator computing device), second computing devices (technician devices), and third computing devices (technician devices). Dispatching methods include receiving inputs through technician indicator fields to store a plurality of technician indicators in the database, receiving inputs through geographic indicator fields to store a plurality of geographic indicators in the database, receiving inputs through one or more technician group indicator fields to associate a first technician group indicator and a second technician group indicator with one of the geographic indicators and to associate the first technician group indicator with the second computing devices and to associate the second technician group indicator with the third computing devices, and generating an auto ETA for a predetermined time to the first technician group and, thereafter, to a second and further technician groups.

### BACKGROUND

### 1. Technical Field

Aspects of this document relate generally to dispatching software and systems.

### 2. Background Art

Various industries include the need to dispatch service providers to locations at the request of a person. For example, cab drivers, repair personnel, roadside assistance providers, and the like need to be dispatched to the location of the person making a request. Some such dispatching services in the art include the use of phone calls by an operator to receive the location and status of a requesting person and phone calls from the operator to service providers or technicians to obtain an estimated time of arrival (ETA) and selecting, by the operator, one of the service providers or technicians to dispatch to the requester. The taxi industry utilizes dispatch services, and this and/or other services include options where a technician or driver to a location may manually input an ETA (direct contact from driver/technician to end customer), or utilizing an automatic ETA setting system/method.

### SUMMARY

Embodiments of dispatching systems may include: a first computing device communicatively coupled with a server, the server communicatively coupled with a database; one or more second computing devices communicatively coupled with the server; one or more third computing devices communicatively coupled with the server; one or more user interfaces displayed on a display of the first computing device and including: one or more technician indicator fields configured to receive one or more inputs to store a plurality of technician indicators in the database; one or more geographic indicator fields configured to receive one or more inputs to store a plurality of geographic indicators in the database; one or more technician group indicator fields configured to receive one or more inputs to associate a first technician group indicator and a second technician group indicator with one of the geographic indicators and further configured to associate the first technician group indicator with the one or more second computing devices and the second technician group indicator with the one or more third computing devices; one or more dispatching interfaces displayed on the display of the first computing device and including an auto ETA field configured to generate a first ETA request signal in response to receiving one or more inputs and, if an acceptable ETA is not received by the first computing device within a predetermined amount of time, configured to automatically generate a second ETA request signal; a first ETA request notification displayed on displays of each of the one or more second computing devices in response to the one or more second computing devices receiving the first ETA request signal, and; a second ETA request notification displayed on displays of each of the one or more third computing devices in response to the one or more third computing devices receiving the second ETA request signal.

Embodiments of dispatching systems may include one or more or all of the following:

The first ETA request notification may include a displayed estimated ETA and a plurality of ETA response fields, each ETA response field displaying an ETA greater than the estimated ETA and configured to generate an ETA response signal corresponding with the displayed ETA in response to receiving one or more inputs.

The one or more technician group indicator fields may be configured to receive one or more inputs to associate, in the database, the predetermined amount of time with the first technician group indicator.

The one or more user interfaces may include one or more continuous fields configured to receive an input to toggle whether the first ETA request notification remains displayed on the one or more second computing devices beyond the predetermined amount of time.

The geographic indicators may include zip codes.

One or more insurance provider interfaces may be displayed on a display of a fourth computing device communicatively coupled with the server, the one or more insurance provider interfaces having one or more insurance group indicator fields configured to receive one or more inputs to associate a first insurance group indicator and a second insurance group indicator with an insurance provider indicator and further configured to associate the first insurance group indicator with the one or more second computing devices and the second insurance group indicator with the one or more third computing devices.

One or more insurance interfaces may be displayed on the display of the first computing device and may include one or more insurance input fields configured to receive one or more inputs to define one or more insurance provider indicators and to associate, through the database, each of the one or more insurance provider indicators with one or more of the geographic indicators.

One or more requester interfaces may be displayed on a display of a fifth computing device communicatively coupled with the server, the one or more requester interfaces displaying a plurality of estimated ETAs, each estimated ETA associated with one of the technician indicators through the database.

The one or more requester interfaces may further include a plurality of technician rankings displayed on the one or more requester interfaces, each technician ranking associated with one of the technician indicators through the database.

Embodiments of dispatching methods may include: receiving one or more inputs, using one or more technician indicator fields displayed on a first computing device communicatively coupled with a server which is communicatively coupled with a database, to store a plurality of technician indicators in the database; receiving one or more inputs, using one or more geographic indicator fields displayed on the first computing device, to store a plurality of geographic indicators in the database; receiving one or more inputs, using one or more technician group indicator fields displayed on the first computing device, to associate a first technician group indicator and a second technician group indicator with one of the geographic indicators and to associate the first technician group indicator with one or more second computing devices communicatively coupled with the server and to associate the second technician group indicator with one or more third computing devices communicatively coupled with the server; generating, in response to receiving one or more inputs using an auto ETA field displayed on one or more dispatching interfaces displayed on the first computing device, a first ETA request signal and, if an acceptable ETA is not received by the first computing device within a predetermined amount of time, automatically generating a second ETA request signal; displaying a first ETA request notification on each of the one or more second computing devices in response to the one or more second computing devices receiving the first ETA request signal, and; displaying a second ETA request notification on each of the one or more third computing devices in response to the one or more third computing devices receiving the second ETA request signal.

Embodiments of dispatching methods may include one or more or all of the following:

Displaying the first ETA request notification may include displaying an estimated ETA and a plurality of ETA response fields, each ETA response field displaying an ETA greater than the estimated ETA and configured to generate an ETA response signal corresponding with the displayed ETA in response to receiving one or more inputs.

The method may include associating, in the database, the predetermined amount of time with the first technician group indicator in response to receiving one or more inputs using the one or more technician group indicator fields.

The method may include toggling whether the first ETA request notification remains displayed on the one or more second computing devices in response to receiving one or more inputs using one or more continuous fields displayed on the first computing device.

The geographic indicators may include zip codes.

The method may include associating a first insurance group indicator and a second insurance group indicator with an insurance provider indicator and associating the first insurance group indicator with the one or more second computing devices and associating the second insurance group indicator with the one or more third computing devices in response to receiving one or more inputs using one or more insurance group indicator fields displayed on a fourth computing device communicatively coupled with the server.

The method may include associating each of one or more insurance provider indicators with one or more of the geographic indicators in response to receiving one or more inputs using one or more insurance input fields displayed on the first computing device.

The method may include displaying one or more requester interfaces on a display of a fifth computing device communicatively coupled with the server, the one or more requester interfaces displaying a plurality of estimated ETAs, each estimated ETA associated with one of the technician indicators through the database.

The method may include displaying a plurality of technician rankings on the one or more requester interfaces, each technician ranking associated with one of the technician indicators through the database.

Embodiments of dispatching methods may include: receiving one or more inputs, using one or more technician indicator fields displayed on a first computing device communicatively coupled with a server which is communicatively coupled with a database, to store a plurality of technician indicators in the database; receiving one or more inputs, using one or more geographic indicator fields displayed on the first computing device, to store a plurality of geographic indicators in the database; receiving one or more inputs, using one or more technician group indicator fields displayed on the first computing device, to associate a first technician group indicator and a second technician group indicator with one of the geographic indicators and to associate the first technician group indicator with one or more second computing devices communicatively coupled with the server and to associate the second technician group indicator with one or more third computing devices communicatively coupled with the server; associating, in the database, a predetermined amount of time with the first technician group indicator in response to receiving one or more inputs using the one or more technician group indicator fields; generating, in response to receiving one or more inputs using an auto ETA field displayed on one or more dispatching interfaces displayed on the first computing device, a first ETA request signal and, if an acceptable ETA is not received by the first computing device within the predetermined amount of time, automatically generating a second ETA request signal; displaying a first ETA request notification on each of the one or more second computing devices in response to the one or more second computing devices receiving the first ETA request signal, the first ETA request notification including an estimated ETA and a plurality of ETA response fields, each ETA response field displaying an ETA greater than the estimated ETA and configured to generate an ETA response signal corresponding with the displayed ETA in response to receiving one or more inputs, and; displaying a second ETA request notification on each of the one or more third computing devices in response to the one or more third computing devices receiving the second ETA request signal.

Embodiments of dispatching methods may include one or more or all of the following:

The method may include, in response to not receiving an acceptable ETA by the first computing device within a second predetermined amount of time, automatically sending a third ETA request signal to one or more sixth computing devices communicatively coupled with the server.

General details of the above-described embodiments, and other embodiments, are given below in the DESCRIPTION, the DRAWINGS, and the CLAIMS.

### BRIEF DESCRIPTION OF THE DRAWINGS

Embodiments will be discussed hereafter using reference to the included drawings, briefly described below, wherein like designations refer to like elements:

FIG. 1 is a block diagram representatively illustrating an implementation of a dispatching system;

FIG. 2 is a user interface of the dispatching system of FIG. 1;

FIG. 3 is another user interface of the dispatching system of FIG. 1;

FIG. 4 is another user interface of the dispatching system of FIG. 1;

FIG. 5 is another user interface of the dispatching system of FIG. 1;

FIG. 6 is another user interface of the dispatching system of FIG. 1;

FIG. 7 is another user interface of the dispatching system of FIG. 1;

FIG. 8 is another user interface of the dispatching system of FIG. 1;

FIG. 9 is another user interface of the dispatching system of FIG. 1;

FIG. 10 is another user interface of the dispatching system of FIG. 1;

FIG. 11 is another user interface of the dispatching system of FIG. 1;

FIG. 12 is another user interface of the dispatching system of FIG. 1;

FIG. 13 is another user interface of the dispatching system of FIG. 1;

FIG. 14 is another user interface of the dispatching system of FIG. 1;

FIG. 15 is another user interface of the dispatching system of FIG. 1;

FIG. 16 is another user interface of the dispatching system of FIG. 1;

FIG. 17 is another user interface of the dispatching system of FIG. 1;

FIG. 18 is another user interface of the dispatching system of FIG. 1;

FIG. 19 is another user interface of the dispatching system of FIG. 1;

FIG. 20 is another user interface of the dispatching system of FIG. 1;

FIG. 21 is another user interface of the dispatching system of FIG. 1;

FIG. 22 is another user interface of the dispatching system of FIG. 1;

FIG. 23 is another user interface of the dispatching system of FIG. 1, and;

FIG. 24 is a diagram representatively illustrating an implementation of a dispatching method using the dispatching system of FIG. 1.

### DESCRIPTION

Implementations/embodiments disclosed herein (including those not expressly discussed in detail) are not limited to the particular components or procedures described herein. Additional or alternative components, assembly procedures, and/or methods of use consistent with the intended dispatching system and related methods may be utilized in any implementation. This may include any materials, components, sub-components, methods, sub-methods, steps, and so forth.

As used herein, the term “technician” is broadly defined as any service provider dispatched to a location to provide a service to a user.

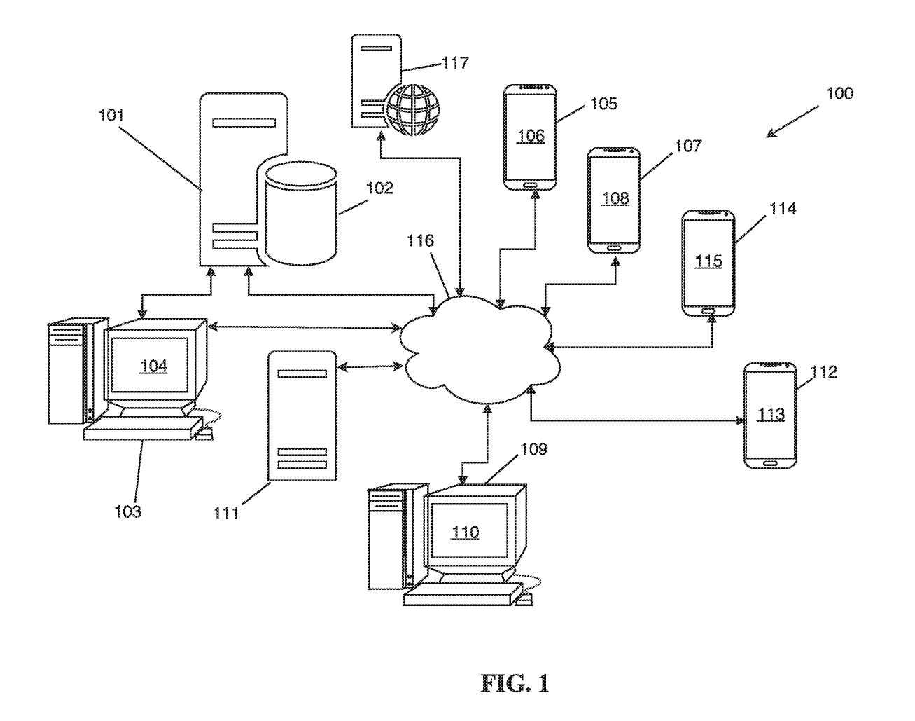

Referring to FIG. 1, a representative example of a dispatching system 100 is illustrated. The representative dispatching system includes a server 101 coupled with a database (DB) 102 and a first computing device (device) 103 is communicatively coupled with the server either directly or through a telecommunications network 116 (such as the Internet). The first computing device includes a display 104 and, although representatively illustrated as a desktop computer, it may be understood that the first computing device could alternatively be a laptop, a tablet, a smartphone, and the like. Similarly, in implementations the first computing device and the server and the database could all be included in the same machine, or could be included on separate virtual servers of the same machine, or in other implementations they could be implemented as distinct components, etc. The server is configured to interact with the database by writing data to the database, querying the database to retrieve data, associating various data with other data within the database, and so forth.

A second computing device (device) 105 is shown communicatively coupled (coupled) with the server through the telecommunications network, the second computing device having a display 106. Only one second computing device is illustrated, for ease of illustration, but it is to be understood that any number of second computing devices may be coupled with the server through the telecommunications network. Additionally, although the second computing device is illustrated as a smartphone, it could alternatively be a laptop, desktop, tablet, and so forth. The second computing devices are associated, through the database, with a first set of technicians, as will be described hereafter.

A third computing device (device) 107 is shown communicatively coupled (coupled) with the server through the telecommunications network, the third computing device having a display 108. Only one third computing device is illustrated, for ease of illustration, but it is to be understood that any number of third computing devices may be coupled with the server through the telecommunications network. Additionally, although the third computing device is illustrated as a smartphone, it could alternatively be a laptop, desktop, tablet, and so forth. The third computing devices are associated, through the database, with a second set of technicians, as will be described hereafter.

A fourth computing device (device) 109 is shown communicatively coupled (coupled) with the server through the telecommunications network, the fourth computing device having a display 110. An insurance server 111 is also shown communicatively coupled with the server and the fourth computing device through the telecommunications network. The fourth computing device is a device used by an insurance carrier or representative to interact with the dispatching system through the telecommunication network, and while the insurance server is shown as a discrete element it could be combined with the fourth computing device, or the two could be on virtual servers in the same machine, or separate discrete elements. While the fourth computing device is shown as a desktop element it could alternatively be a laptop, a tablet, a smartphone and the like.

A fifth computing device (device) 112 is shown communicatively coupled (coupled) with the server and/or the insurance server through the telecommunications network, the fifth computing device having a display 113. Only one fifth computing device is illustrated, for ease of illustration, but it is to be understood that any number of fifth computing devices may be coupled with the server and/or insurance server through the telecommunications network. Additionally, although the fifth computing device is illustrated as a smartphone, it could alternatively be a laptop, desktop, tablet, and so forth. The fifth computing devices are associated, through the database, with service requesters, such as by non-limiting example a driver needing roadside assistance, as will be described hereafter.

A sixth computing device (device) 114 is shown communicatively coupled (coupled) with the server through the telecommunications network, the sixth computing device having a display 115. Only one sixth computing device is illustrated, for ease of illustration, but it is to be understood that any number of sixth computing devices may be coupled with the server through the telecommunications network. Additionally, although the sixth computing device is illustrated as a smartphone, it could alternatively be a laptop, desktop, tablet, and so forth. The sixth computing devices are associated, through the database, with a third set of technicians, as will be described hereafter.

Although three sets of technician-associated computing devices are illustrated (second, third, and sixth computing devices), corresponding with three sets of technicians, it is to be understood that any number of sets of technicians could be organized and associated through the database, so that by non-limiting example there could be a fourth set of technicians (seventh computing devices), a fifth set of technicians (eighth computing devices), and so on.

A web server 117 is also illustrated, which may serve to provide an internet-based interface through which any of the computing devices may interact with the server and/or the database, such as by any user visiting a website through a device. Alternatively, any of the computing devices may interact with the server and/or database through a software app and without the user needing to input a website address. Only one web server is shown, for ease of illustration, but it is to be understood that one or more website servers may be utilized by the insurance carrier for any of the devices to interact with the insurance server, with a database coupled with the insurance server, and so forth. Any web server may be a discrete server as shown in FIG. 1, or a virtual server housed on the same machine as the insurance server or server 101, and/or housed together with one or more of the first or fourth computing devices, etc. Although not illustrated, the insurance server may include, or may be coupled with, a database for the storage and retrieval of data.

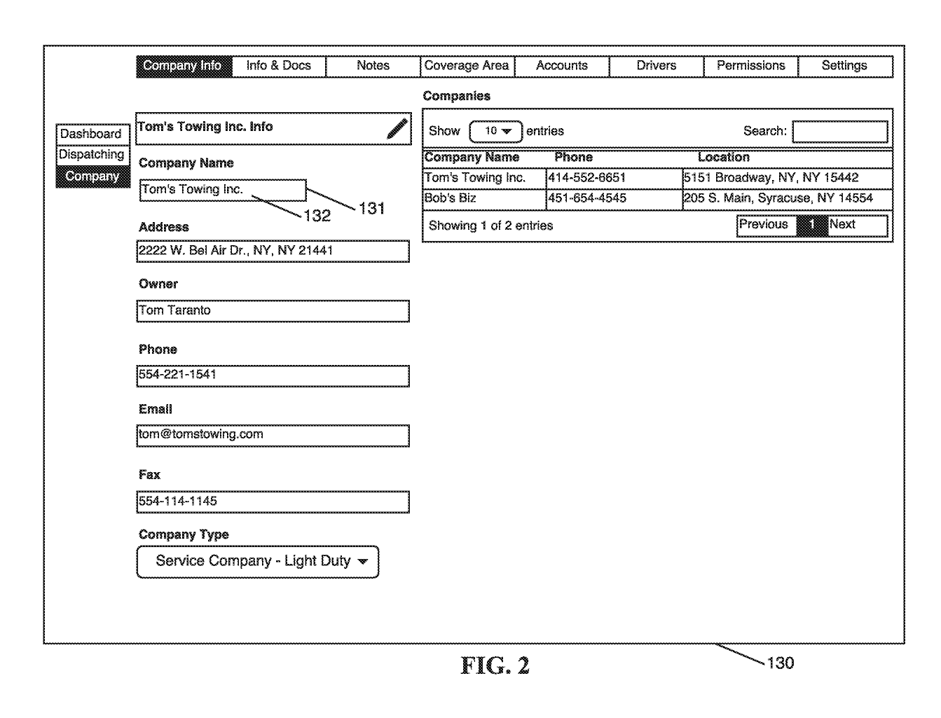

FIG. 2 illustrates a non-limiting representative example of an implementation of an administrator interface (user interface) (interface) (UI) 130 displayed on display 104. A number of fields are shown, on the left hand side a menu includes “dashboard,” “dispatching,” and “company” selectors, which when selected bring up different interfaces and/or different portions of interface 130. The “company” selector is selected as indicated by its dark coloring, though other methods may be used to indicate selected tabs and elements. A menu across the top is displayed including a variety of selectors, and the “company info” selector is seen selected. This screen is used to store and/or edit data related to a “company” within the database of the dispatching system. A company indicator field 131 is shown, into which a user may input a company indicator 132. In this representative example it may be typed in directly on this screen, or it could be typed in using the edit selector (pencil image) shown directly above. Fields are also included for the address of the company, the company owner, phone, email, fax number, and company type (selectable here through a dropdown menu which menu itself may be edited through another interface). Other information could be included in other implementations, and the right hand side of interface 130 shows a list of all companies entered into the database, showing the company names, phone numbers, and addresses (which options themselves may be edited in another interface) and the number of entries displayed may be edited through the shown dropdown menu.

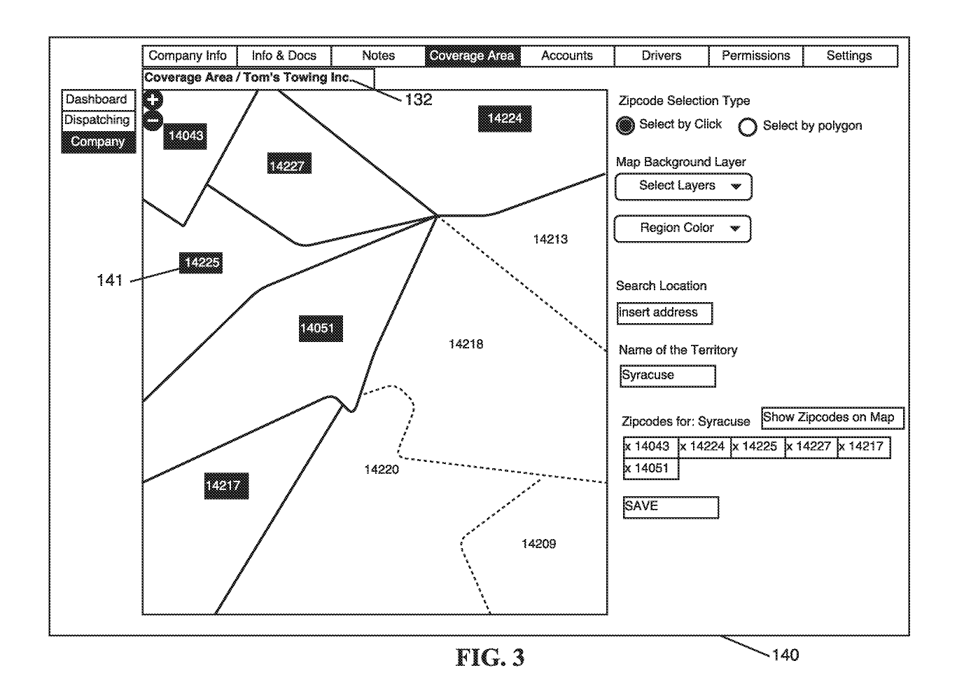

FIG. 3 illustrates a representative example of an administrator interface (user interface) (interface) (UI) 140 which may be accessed from the previous interface by selecting the “coverage area” selector from the top menu, and is an interface used to associate geographic areas with the company through the database. One of the companies shown on the previous interface, “Tom's Towing Inc.,” is the company associated with the geographic selections shown on this screen, though naturally every company entered into the database through the previously described interface can have its own geographic information entered in through interface 140.

Interface 140 shows the company indicator 132 for the company associated with this specific interface, and the interface includes a map with zip codes and zip code boundaries shown. The zip codes are representative examples of geographic indicators 141 which may be associated with the company through the database—in other implementations the geographic indicators could be defined by county lines, city boundaries, city blocks or groups of city blocks, longitude and latitude, and so forth. Interface 140 is used to associate, through the database, selected geographic indicators 141 with a company indicator 132. In the example shown the interface 140 pulls up map information which is previously stored in the database or the server, and the administrator may move the map such as by dragging with the mouse cursor, may zoom in or out such as using the mouse wheel or the plus/minus indicators (or like elements), and may click within any geographic zone to select that geographic indicator and add it to a list for the company. When a geographic zone is selected this may be seen visually such as, by non-limiting example, darkening/thickening the borders of that geographic zone and/or highlighting the correlated geographic indicator on the map (as both seen in FIG. 2), or by coloring in or changing the color of the geographic zones selected, or by other methods.

On the right hand side it may be seen that the geographic zone selection method may be toggled between clicking within an area (currently selected) or by drawing a polygonal area. The map background area may be altered via a dropdown menu, currently only zip code boundaries are shown, but other views may show street level information, or cities, counties, states, bodies of water, longitude/latitude, and other information. An address may be placed in the shown search bar to center the map on any address. A name may be given t the territory here, shown as “Syracuse,” and the selected zip codes are shown in a list on the right hand side, each having an “x” which may be selected to remove the zip code from the listing (which may alternatively be accomplished by clicking on an already selected zip code on the map), and the “shop zip codes on map” selector may be toggled to show or hide zip codes. The “save” selector may be clicked on to save the selected information to the database. In the representative example selecting “save” would associate, in the database, the “Tom's Towing Inc.” company indicator with the selected geographic indicators for the city of Syracuse. Any number of territories and associated geographic indicators may be added to the database, and the representative methods of inserting the information to be added to the database are naturally only representative examples of how the data may be added or edited, in other implementations information may be dragged from one area to another, typed in manually, or entered in any other way. A “Region Color” dropdown is shown which may be used to alter the color of selected geographic zones.

To put interface 140 into perspective, in the representative example the company indicator 132 is associated with a fictional towing company, and the towing company covers some portions, but not all portions, of the city of Syracuse, N.Y. Accordingly, the geographic zones covered by the towing company are entered into the database so that later, during dispatching, the towing company will only be called upon to provide towing or other roadside assistance services in geographic areas which it is known to cover.

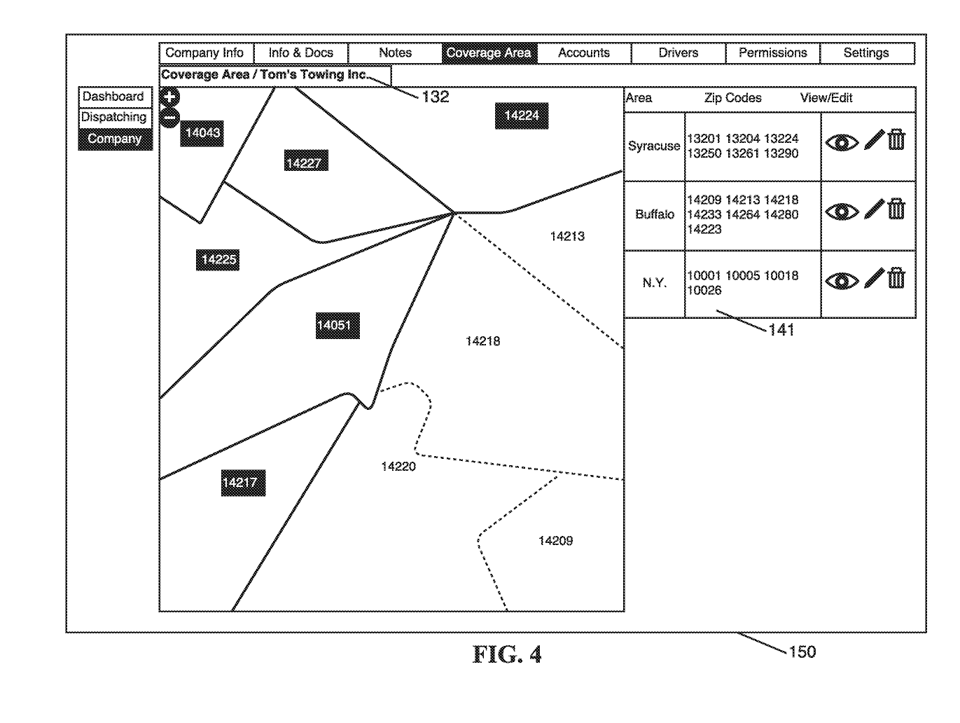

FIG. 4 shows a representative example of an administrator interface (user interface) (interface) (UI) 150, which includes some of the same elements of FIG. 3 but is an interface seen when the Save button on the previous screen is selected. The map is still visible and may be dragged, zoomed, etc., and a table on the right side of the interface shows all areas (Syracuse, Buffalo, and N.Y.) that have been entered for the company associated in the database with the company indicator 132, along with the selected geographic indicators 141 for each area. If the view (eye icon) is selected for any area the map will center over that area, if the edit (pencil icon) is selected the previous screen (interface 140) will be shown to edit the geographic indicators, and if the delete (trash icon) is selected the entire area will be deleted from the database. This screen shows that, for each company, any number of areas may be associated with the company indicator, and any number of geographic indicators pertaining to a given area may be associated with the company indicator.

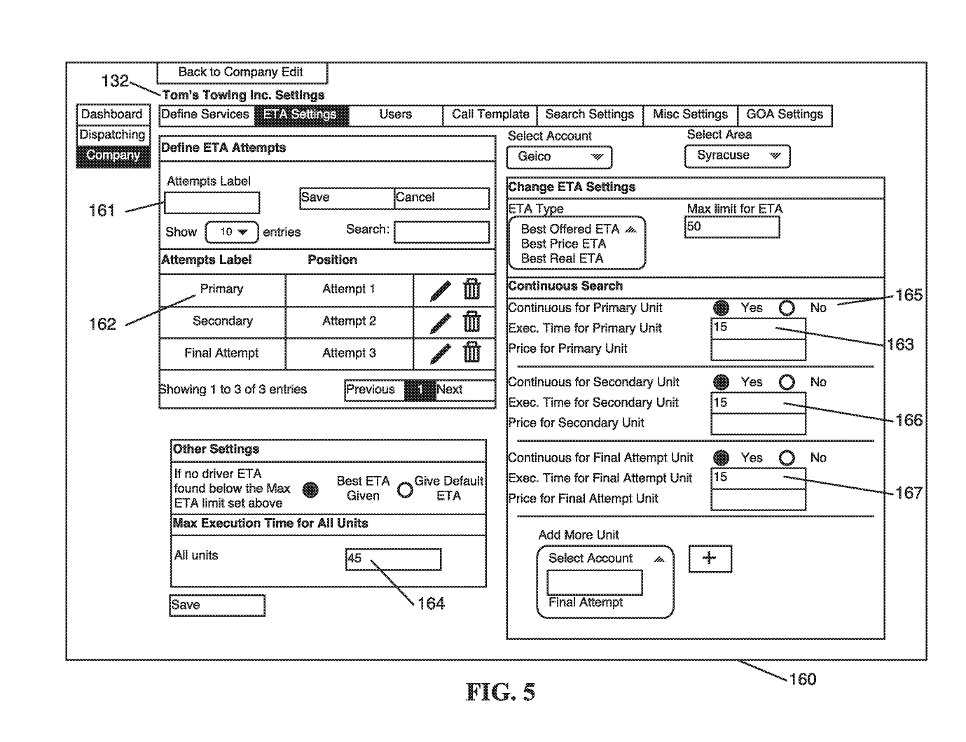

FIG. 5 shows a representative example of an administrator interface (user interface) (interface) (UI) 160 which is used to input other information and associate it with an entered company. The company indicator 132 is seen at the top of the screen, along with a variety of menu items. This interface may be arrived at by selecting a menu item on interface 150—for example the “settings” top menu item of user interface 150 (which may default to showing a “Define Services” interface—and then by selecting a visible “ETA Settings” menu item the user may arrive at interface 160). The “Back to Company Edit” menu item on interface 160 may be selected to return to interface 150. The “ETA Settings” interface 160 is used to define certain aspects of the operation of estimated times of arrival (ETAS) within the dispatching system. For background, in the representative example the “administrator” operating the dispatching system through the first computing device is a provider of dispatching services for roadside services and the “companies” entered into the system are various roadside service providers, though this is simply one representative example and the system could be used for any services which benefit from dispatching services. But, referring to the example of roadside services, when a user requires roadside assistance, it is useful to provide an estimated time of arrival (ETA) to the person and/or to that person's insurance provider. A request for roadside assistance may be initiated by a driver through his/her insurance company, such as by a phone call to the insurance company or through an app associated with the insurance company on the driver's phone, at which point the insurance company may make a request to the administrator (dispatch service provider) by phone or, more commonly, through a digital request through a software application of the administrator. Such digital requests may be set to expire within a certain amount of time (such as between 1-2 minutes) so that, if the administrator cannot obtain an ETA from a company (or a company technician) and provide that ETA to the insurance carrier, the opportunity may be lost. Additionally, the insurance company may have a set maximum ETA that is acceptable, such that if the administrator can respond within the 1-2 minute deadline with an ETA that is below the maximum acceptable ETA (for example an ETA of 45 minutes or less), the administrator may automatically be awarded the dispatching job.

In light of the above circumstances, it can be difficult to achieve a reasonable ETA from a technician within the short time frame in order to respond to the request from the insurance provider. If a dispatcher calls one technician by phone, and does not receive a response or receives an ETA that is too long, and the dispatcher then needs to call another technician, or more than one more technician, the short time frame of 1-2 minutes may pass and the job may be lost. The dispatching system disclosed herein solves these issues, among others.

Referring again to FIG. 5, a number of ETA settings may be defined by the administrator for a given company indicator 132. In the “Define ETA Attempts” window a number of attempts labels may be added to the database, associated through the database with the company indicator, and placed in selected positions relative to one another. For example in the example of FIG. 5 there are three attempt levels, labeled “Primary,” “Secondary,” and “Final Attempt,” and are positioned in the listed order, and these may be edited or deleted by selecting the pencil/trash icons, respectively. Additional attempts could be added by entering a new label in the “Attempts Label” input field atop the table and selecting “Save” which will by default place the new attempt in the fourth position though the relative positions may be edited by selecting the edit icons.

On the right side it may be seen that a specific insurance provider may be selected through a dropdown menu and a certain area, so that the specific ETA settings for each company may be set for each area and for each insurance carrier. An ETA type may be selected from a dropdown menu—the Best Offered ETA is the option that will be described in most detail in this disclosure, but it will be pointed out that the Best Price ETA is self-explanatory and the Best Real ETA is based only on GPS estimated ETA. In this example the Best Offered ETA is selected, which will be explained in further detail below. A max limit may be set for the ETA, here it is set to 50 minutes (the max limit is the administrator-defined “acceptable ETA.”

Under the “Continuous Search” field it is seen that there are options for each of the attempts labels previously discussed. The attempts labels are technician group indicators 162 and were entered in the technician group indicator field 161. In this case there is a first technician group indicator, a second technician group indicator, and a third technician group indicator, and fewer or more could be utilized in any other implementation. For each attempt label there is a continuous field 165 on the right side to toggle between continuous or non-continuous, along with a predetermined amount of time 163 for the first technician group indicator (in this case the Primary group). The predetermined amount of time is set to 15 seconds, a second predetermined amount of time 166 is set to 15 seconds and a third predetermined amount of time 167 is set to 15 seconds, and all three technician group indicators are set to “continuous” mode. A price field for each technician group indicator is available (which would be applicable if the Best Price ETA option is selected)—in this example these fields are all left blank since the Best Offered ETA option is selected.

If an additional technician group indicator 162 is added on the left side using the described technician group indicator field then the “Add More Unit” on the right side may be used to select the new technician group indicator through the dropdown and pressing the plus icon will add the three fields (continuous field, predetermined amount of time, price input field) for this new technician group indicator.

On the left bottom side a max execution time 164 for all units is shown, which is simply an addition of all execution times set on the right hand side—here they add up to 45 seconds. There is also a toggle that comes into play if no technician responds with an ETA below the Max limit, the toggle allows the administrator to have the best ETA given come back to the dispatcher or, alternatively, to have a default ETA come back to the dispatcher (either of which would then be relayed to the insurance carrier).

For example, in a representative method of dispatch, an incoming digital request is received by the administrator, either through the dispatch software, or other software, or through a phone call, along with a stated or unstated time limit for receiving a response from the dispatcher. The dispatcher then enters one or more inputs (for example the address of the driver needing roadside assistance, if necessary, and/or execution of an auto ETA field, described later) which automatically will initially send an ETA request to all technicians for the associated insurance carrier that have been set to “Primary” (or whatever the first technician group indicator is) and will not send the ETA request to the “Secondary” (or other named second technician group indicator) until 15 seconds have passed. If an acceptable ETA (one under the 50 minute max limit) is received by any of the Primary group then no ETA request will be sent to the Secondary group—but if 15 seconds pass with no acceptable ETA received then the ETA request will be sent to the Secondary group (during this time the ETA request will remain open to the Primary group since the “Continuous for Primary Unit” is toggled on. If during the second 15 seconds any acceptable ETA is received the ETA request will not go out to the third group (Final Attempt), but if no acceptable ETA is received in that time the request will go out to the Final Attempt group in similar fashion. If, after sending the ETA request to all groups, no acceptable ETA is received, then in this case since “Best ETA Given” is selected the best ETA will be communicated to the dispatcher who can then relay that to the insurance carrier. Naturally, if the execution times are edited, or other items toggled, the behavior of the system will change predictably—for example if “Continuous” is toggled off at any level then the request will not remain open to that level after that level's predetermine amount of time has elapsed.

In some implementations the system may be set so that, even if an acceptable ETA is received, the system will still send out an ETA request to the second, third, and other groups in order to see if any better ETAs are received, or in other implementations the ETA request only remains open until the end of that level's predetermined amount of time. In other implementations the system could be set to automatically close all requests as soon as an acceptable ETA is received.

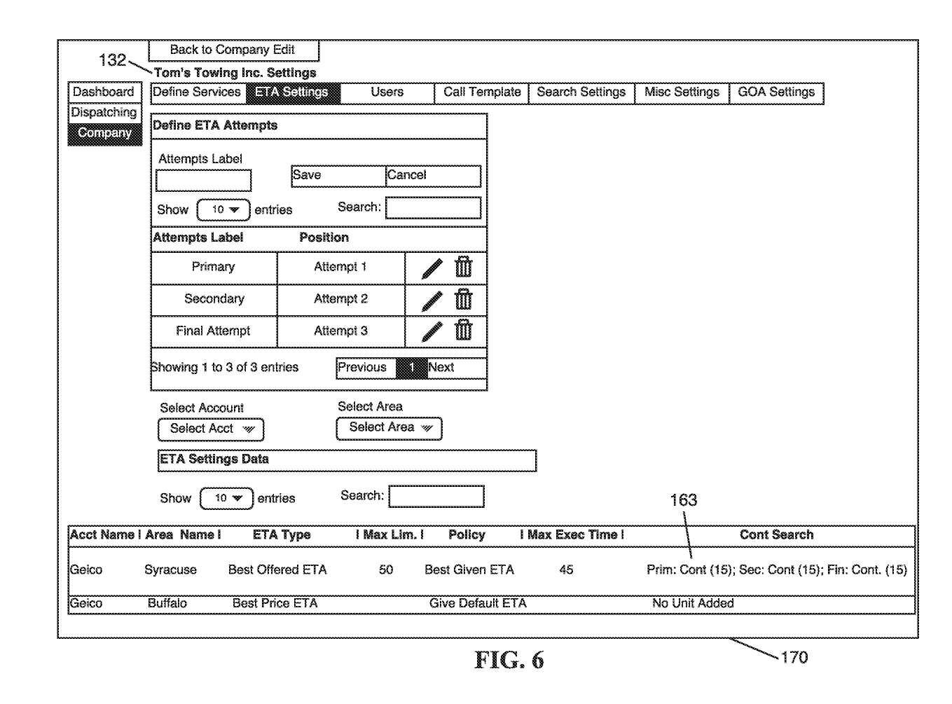

FIG. 6 shows administrator interface (user interface (interface) (UI) 170 which is visible when the bottom left “Save” selector is selected on interface 160. Interface 170 simply shows a summary of the ETA settings associated with the company indicator 132 for each account (each account associated with an insurance provider and an area), and the bottommost table shows the settings in each locale which may be scrolled through to see a summary, showing for example the predetermined amount of time 163 (and second and third predetermined amounts of time), the continuous setting at each level, etc.

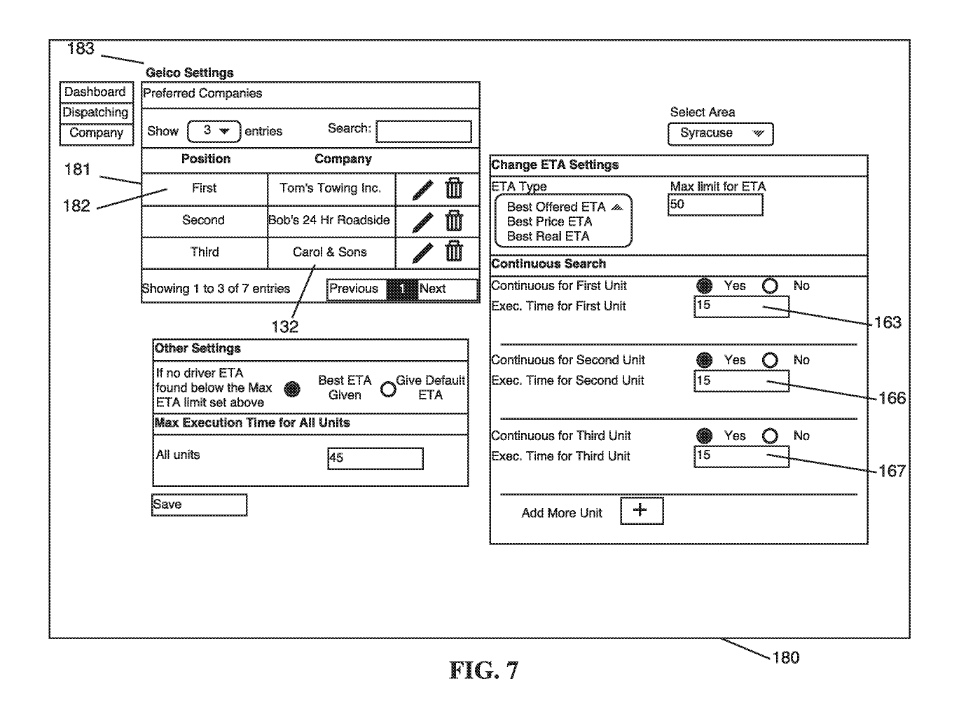

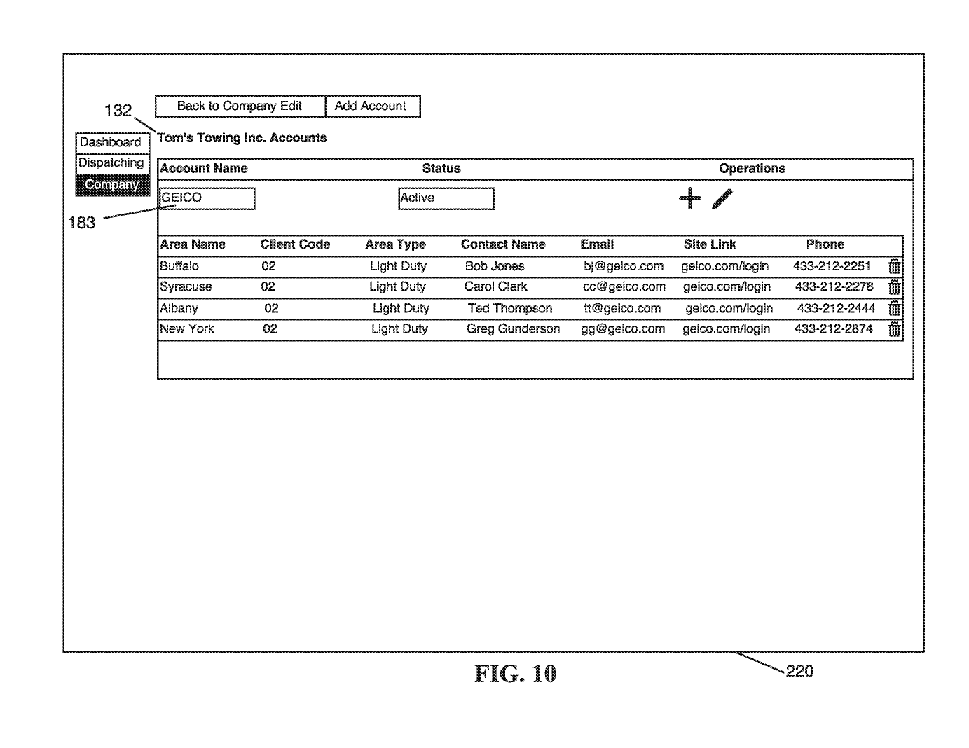

FIG. 7 shows a representative example of an insurance provider interface (user interface) (interface) (UI) 180 visible to an insurance provider through the fourth computing device 109 so that the insurance provider may select its own order of preferred companies to provide roadside assistance. The insurance provider indicator 183 is shown, which was entered into the system by the administrator along with other insurance provider info (shown and described later in FIG. 10), and the insurance carrier may enter, in an insurance group indicator field 181, an insurance group indicator 182. In this case there is a first insurance group indicator (“First”), a second insurance group indicator (“Second”), and a third insurance group indicator (“Third”). This option is very similar to that described with respect to FIG. 6 except that in this case the insurance carrier selects the options, including selecting a first company as the first position, a second company as the second position, and so on. The insurance carrier provides the predetermined amounts of time 163, 166, 167, toggles the continuous switches as desired, sets the max limit (acceptable ETA) as desired, selects between Best Offered ETA, Best Price ETA, Best Real ETA as desired. In other implementations the administrator may set some of these options and only have some of the options visible or editable directly by the insurance carrier. The operation in this case would be similar to that described above for the FIG. 6 settings except that the first ETA request would go out to technicians of the first company, the second ETA request (if applicable) would go out to technicians of the second company, and so forth. Presumably the insurance carrier would only (or only be allowed to) select companies that are operating in the locales/areas selected.

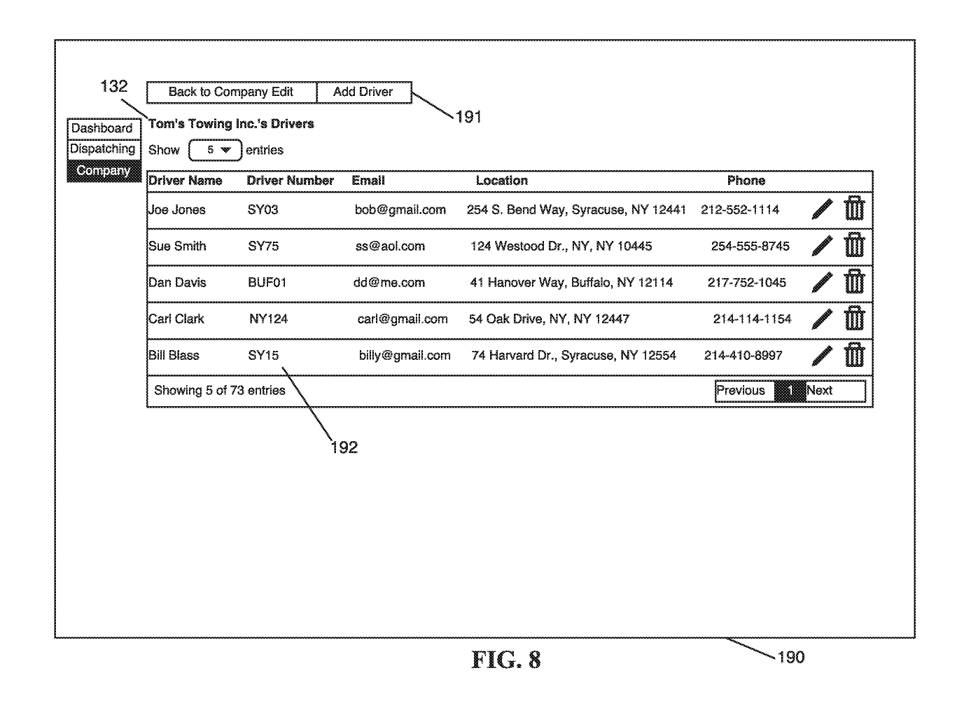

FIG. 8 shows a representative example of an administrator interface (user interface) (interface) (UI) 190 allowing the administrator to associate specific technicians with specific companies. The company indicator 132 for the selected company is shown, and the table below shows all drivers associated in the database with that company indicator. The table has a technician indicator field 191 (shown as a “Add Driver” field) which the administrator may select to input a driver's or technician's information, including a technician indicator 192. Edit and delete functions are shown, and for each driver it is seen that name, driver indicator (driver number), email, location, and phone are listed in a list.

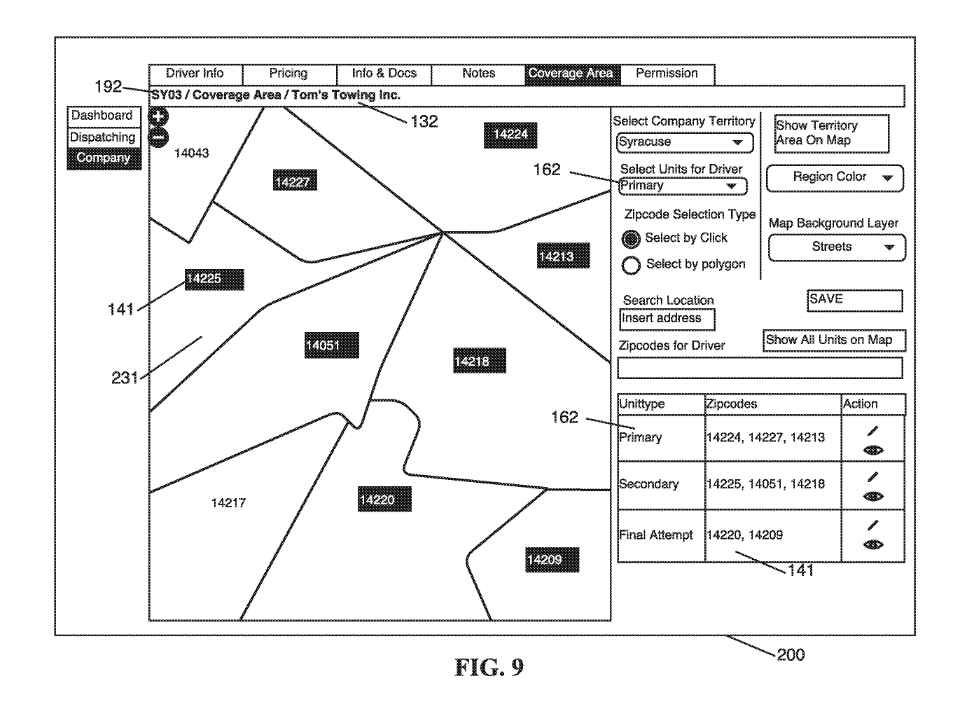

FIG. 9 shows a representative example of an administrator interface (user interface) (interface) (UI) 200 which allows the administrator to select an area (here Syracuse), and select the geographic indicators 141 by clicking in a geographic indicator field 231, similar to that previously described with respect to FIG. 3, but in this case the database is associating a specific driver with a specific technician group indicator 162 (first, second, third, etc.) for specific geographic indicators 141. The topmost “Select Units for Driver” dropdown menu allows the administrator to select the various technician group indicators one at a time and add all geographic indicators desired for that driver for that technician group indicator. It can be seen from FIG. 9 that the technician indicator 192 is seen on the screen. UI 200 thus associates, in the database, the technician group indicators with specific geographic indicators for a specific area for a specific technician indicator.

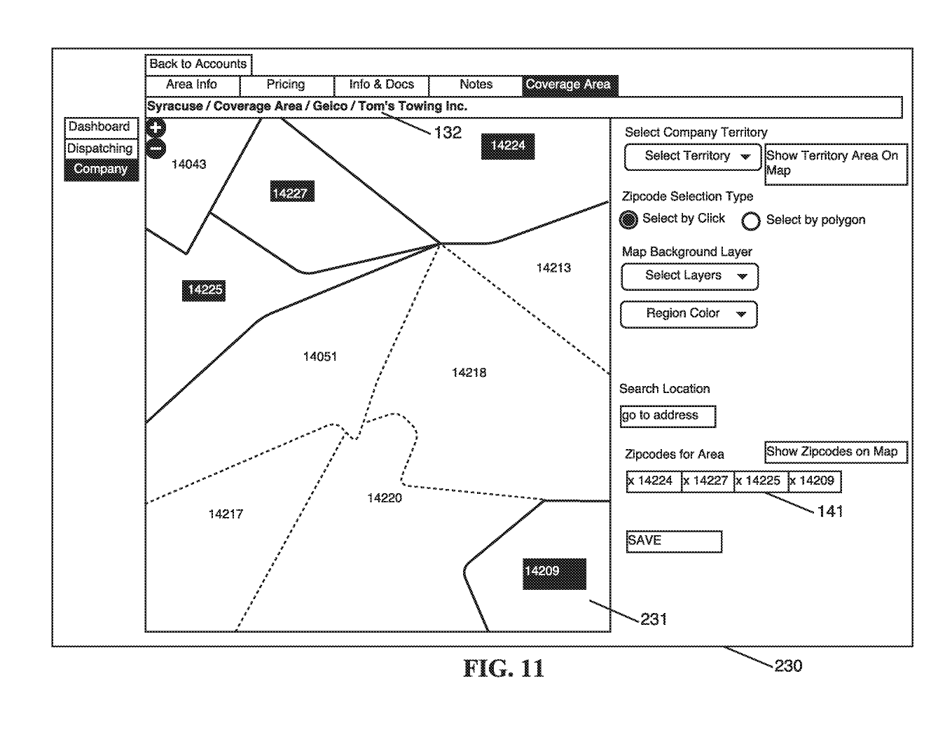

FIG. 10 shows an insurance interface (user interface) (interface) (UI) 220 of the system which includes a number of insurance input fields. “Add Account” allows an insurance carrier indicator 183 to be associated with a specific company indicator 132, and the status may be set to Active or otherwise, and the plus sign may be selected to add new areas, client codes, area types, contact names, email addresses, site links, and phone numbers. The delete icon may be used to delete any of the entries. In this case only one insurance carrier is shown but naturally each company indicator may be associated with multiple insurance carriers (i.e., insurance carrier indicators) through the database. More insurance input fields are shown in FIG. 11, which is an insurance interface (user interface) (interface) (UI) 230 which allows the administrator to associate an area's geographic indicators 141 (by selecting geographic indicator fields 231 and selecting “Save”) with a certain insurance provider indicator for a certain company indicator 132.

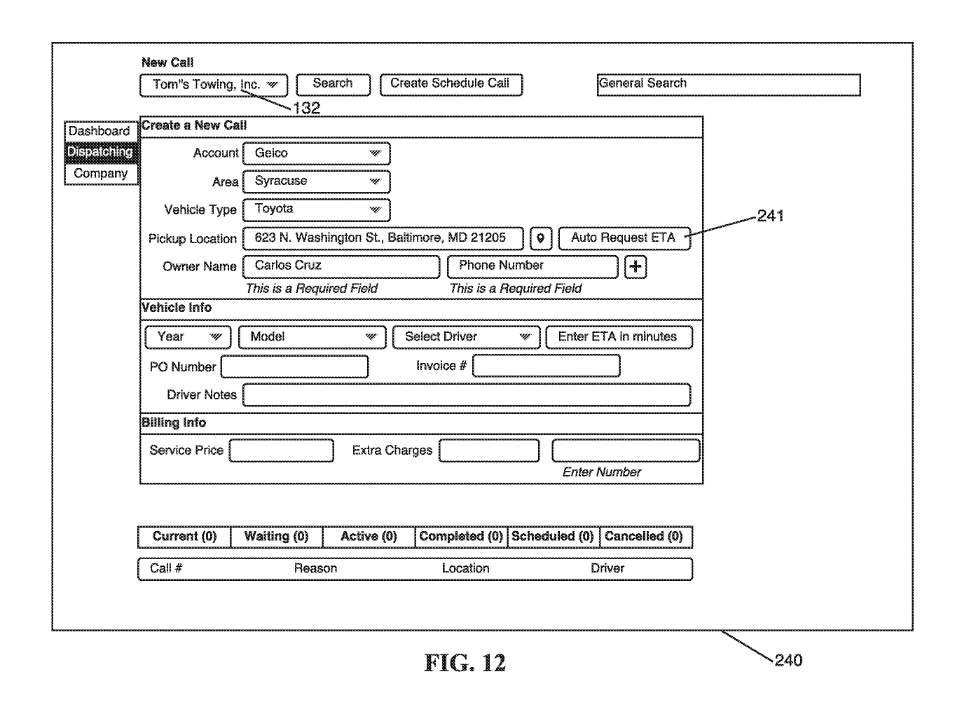

FIG. 12 shows a dispatching interface (user interface) (interface) (UI) 240 which allows the administrator or a dispatcher to send out an auto ETA request. The dispatcher has received an ETA request from an insurance carrier, and the dispatcher selects a company indicator 132, an insurance account, an area, and inputs the information about the vehicle and person for which roadside assistance is required (in some implementations all of this information could be auto-populated through communicating with the application programming interface (API) of the insurance company software), and then the dispatcher presses or selects the auto ETA field 241 to initiate the process previously described with respect to FIG. 5. Once the auto ETA field has received an input to begin the auto ETA request the first ETA request signal (send to the Primary list or otherwise named first list), second ETA request signal (sent to the second list or group), third ETA request signal (sent to the third list or group) and so forth, occur automatically without further interaction by the dispatcher. In implementations, if no ETA is received from any of the technicians, the request is kicked back to the dispatcher so that manual calls or other communications may be done to get an ETA to send to the insurance provider.

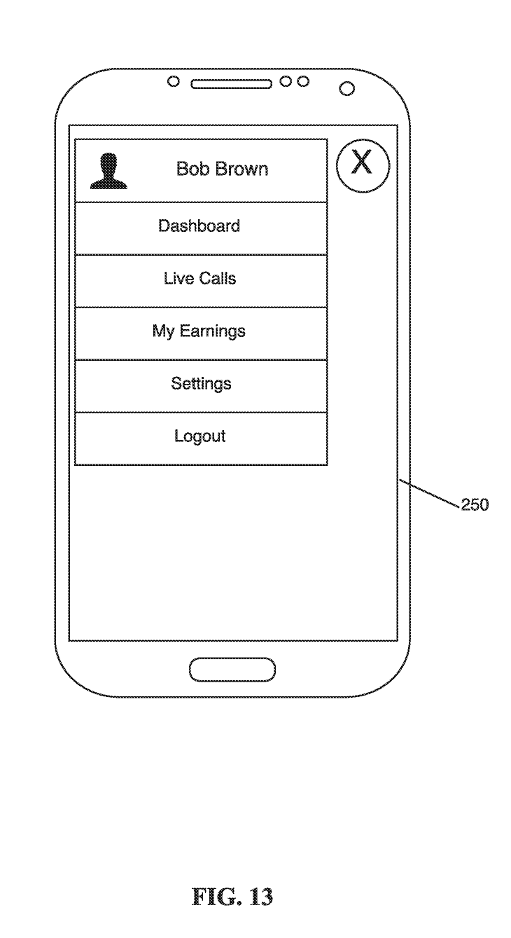

FIG. 13 shows a technician interface (user interface) (interface) (UI) 250 displayed on one or more of the second, third, sixth and so forth computing devices (the devices associated with the technicians through the database). Each computing device that is a phone is associated with the technician through the database, among other ways, by the phone number associated with the phone. The interface includes a relatively self-explanatory menu showing the user name, a dashboard selector, a live calls selector, an earnings selector, a settings selector and a logout selector.

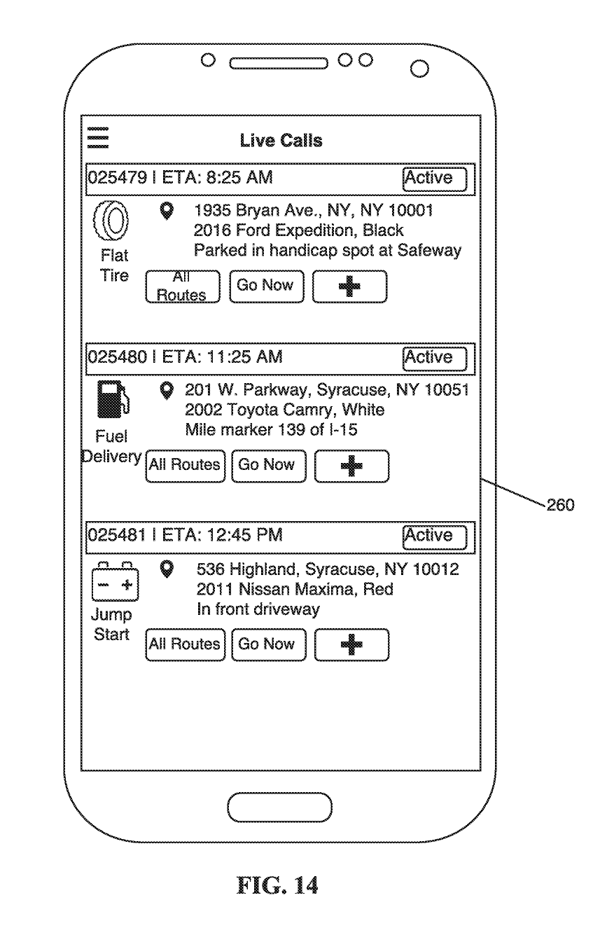

FIG. 14 shows a technician interface (user interface) (interface) (UI) 260 accessible through the aforementioned live calls selector, which shows all jobs that are active for the technician, or in other words it shows all the jobs on that technicians queue, including showing the type of assistance needed, the address, an estimated ETA (based on GPS info or on the technician's provided ETA), whether the job is active or otherwise (for example if the person fixes the issue themselves and communicates a cancelation the job would not be active), and selectors allowing the user to see all map routes to the location, whether to go now to the site to provide the needed assistance, or whether to select other options (through the plus sign).

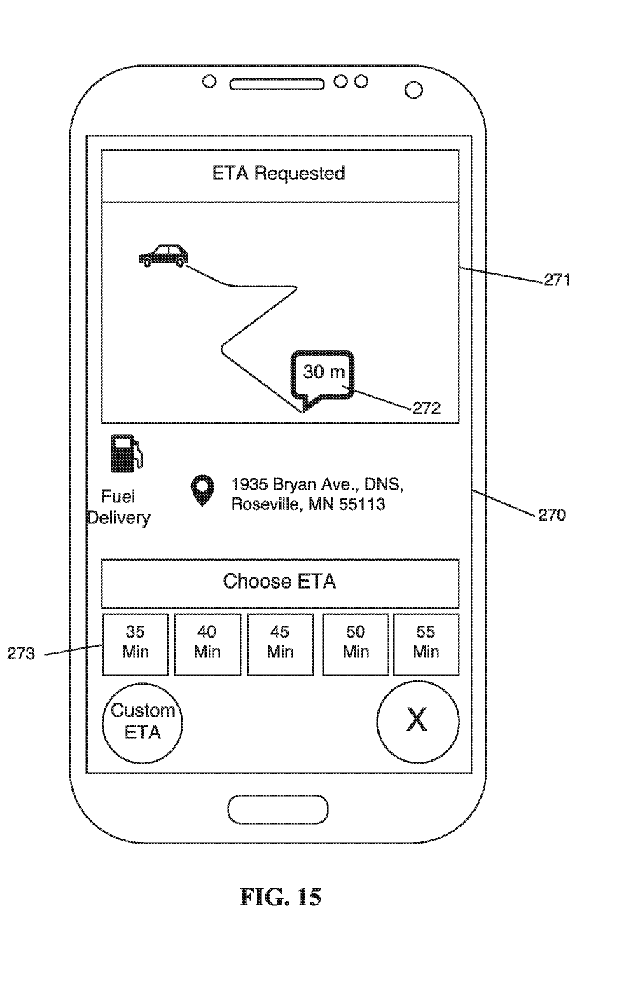

FIG. 15 shows a technician interface (user interface) (interface) (UI) 270 displayed on a technician computing device and showing an ETA request notification 271 as displayed on the display of the technician's computing device. The ETA request notification in this implementation is an image of a map showing the quickest route the technician could take to the person needing roadside assistance, and an estimated ETA 272 determined, in this implementation, by a GPA-based estimation. The ETA request notification also shows the type of assistance needed and the address where assistance is needed. A n umber of ETA response fields 273 are displayed, each of which is a multiple of 5 and is greater than the estimated ETA, and the technician may, knowing how much time he/she will spend at a present location and the travel time to the new location, provide an ETA by selecting any of the ETA response fields. The user may instead select Custom ETA to enter a different time or, alternatively, “X” out of the screen to not provide an ETA. The ETA request notification shown here is the same that would be provided as a first ETA request notification to the first set of technicians (Primary), the second ETA request notification to the second set of technicians (Secondary), the third ETA request notification to the third set of technicians (Third/Tertiary or Final), and so forth. When a user selects one of the ETA response fields an ETA response signal is transmitted through the telecommunications network to the server and/or to the first computing device to the dispatcher.

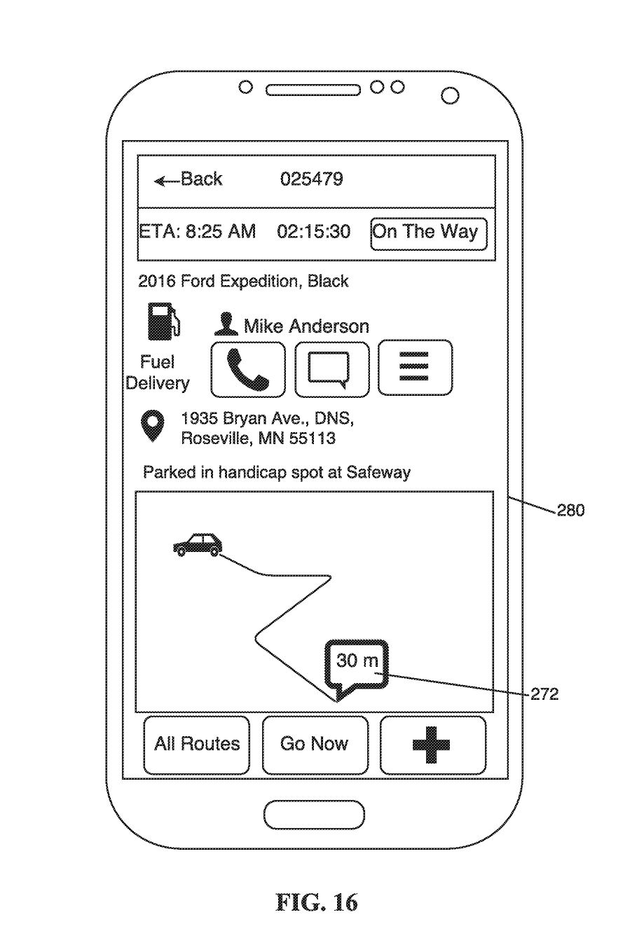

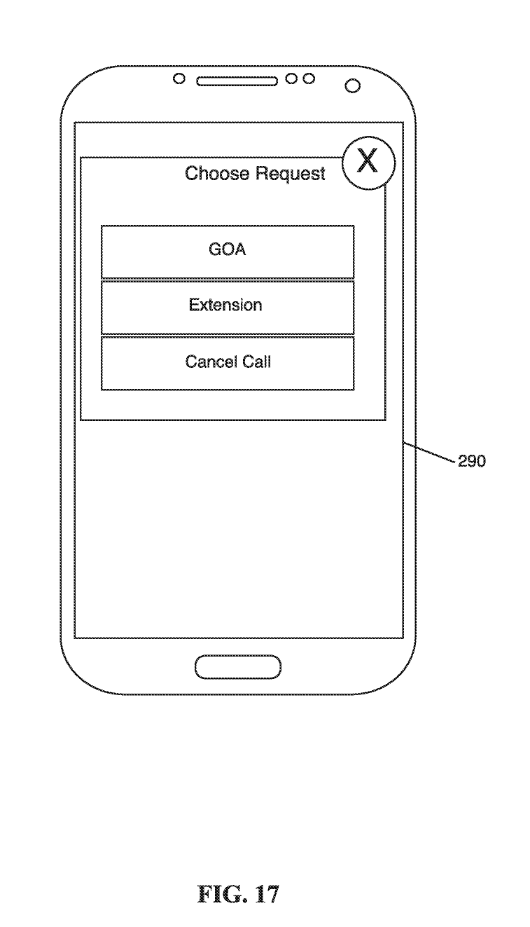

FIG. 16 shows a technician interface (user interface) (interface) (UI) 280 that is visible once a technician has indicated he/she is on the way to a roadside assistance location. The ETA is shown (either GPS estimated or the ETA provided by the technician) along with the time to arrival, the type of assistance required, the person needing assistance, selectors to call or message the person or to see more information, the address, a description of the location of the vehicle, a map again showing the ETA, and a selector to see other routes on the map, to go by way of the now shown route, or a plus indicator to see other options. The plus option may bring up the user interface of FIG. 17, which shows a technician interface (user interface) (interface) (UI) 290 which includes selectors to indicate that the person was gone on arrival (GOA), an extension input to indicate that more time is needed, a cancel call selector to indicate that the job has been cancelled, or an “X” to close this screen

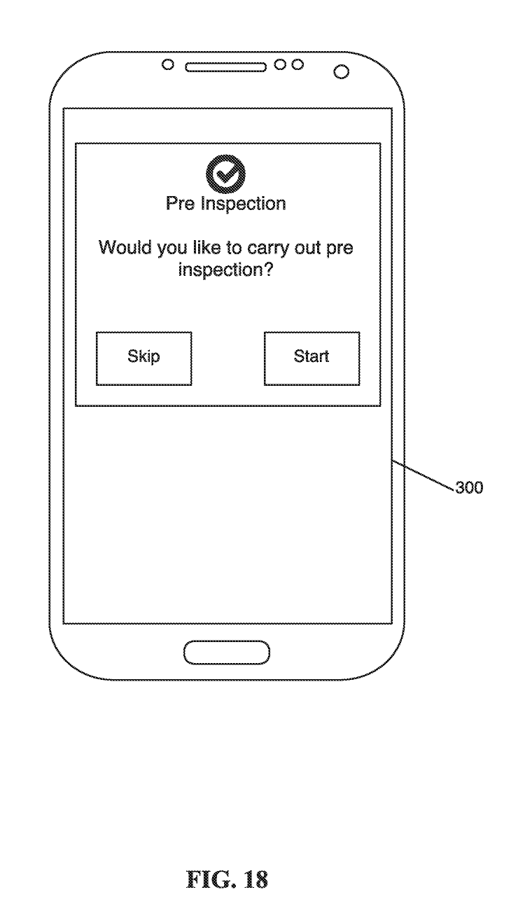

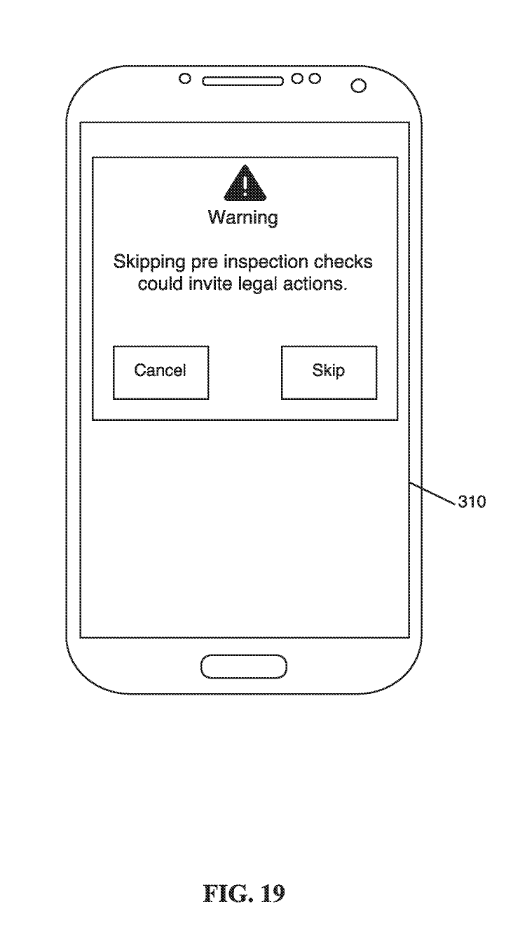

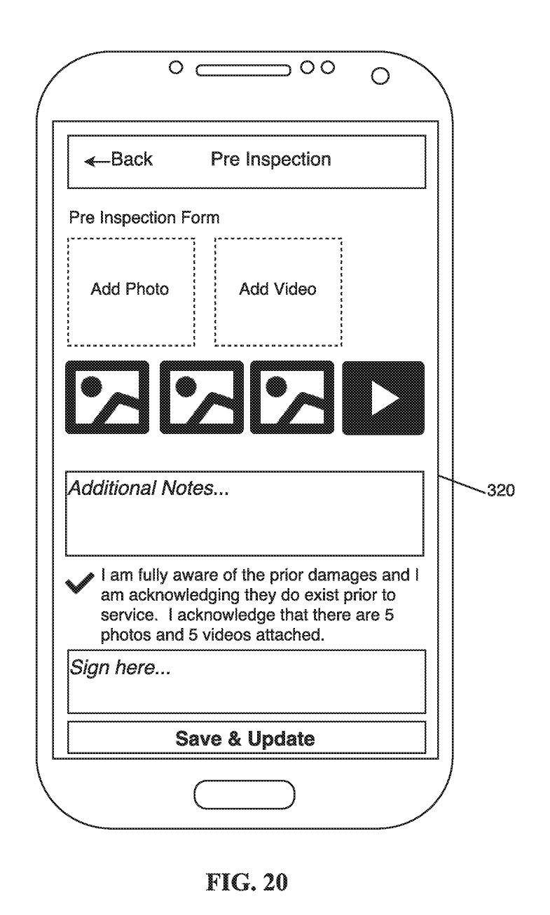

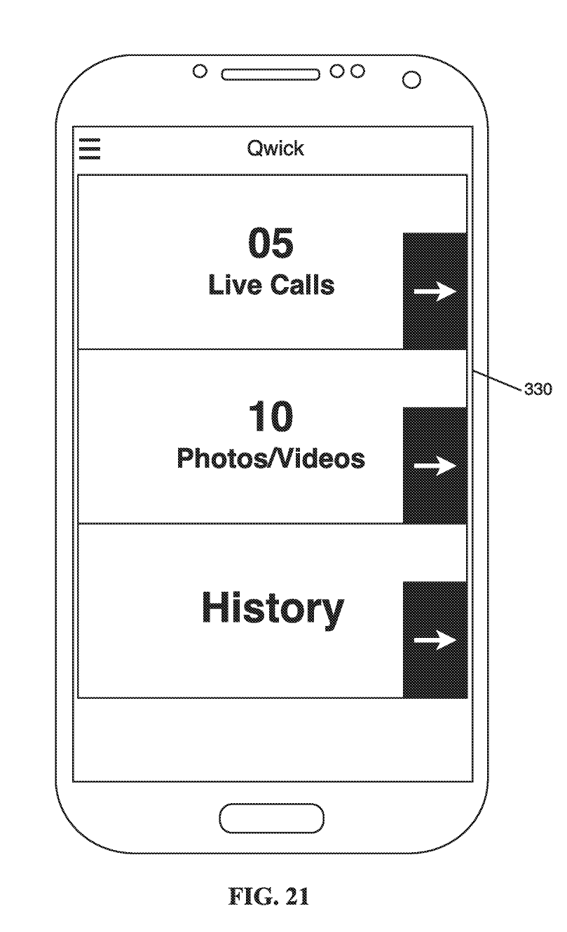

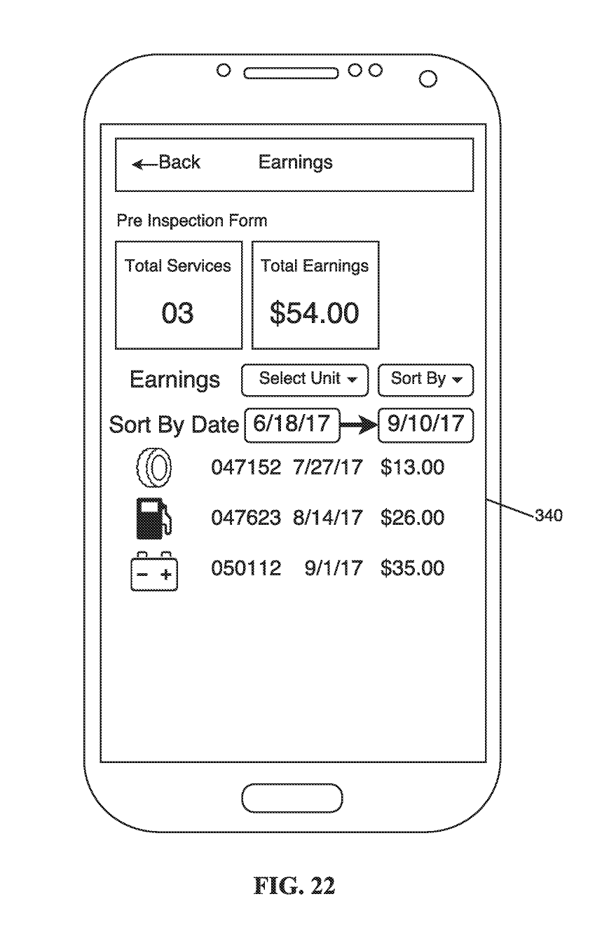

FIG. 18 shows a technician interface (user interface) (interface) (UI) 300 which shows a question regarding pre-inspection prior to providing the roadside assistance and selectors to skip or start the pre inspection. FIG. 19 shows a technician interface (user interface) (interface) (UI) 310 which is a warning regarding skipping pre inspection checks and selectors to cancel the skip or to go ahead and skip. FIG. 20 shows a technician interface (user interface) (interface) (UI) 320 which includes a pre inspection form including allowing the technician to add photos and videos, view the photos and videos, add additional notes, show a disclaimer to the vehicle driver for him/her to review and sign the waiver, and save and update the form. Three photos are shown, one video (with the “play” icon), and the others may be seen by scrolling those thumbnails to the left or right. FIG. 21 shows a technician interface (user interface) (interface) (UI) 330 which shows the number of calls (live calls) in the technician's queue and a link to them, the number of photos/videos uploaded and a link to them, and a history link to show old jobs. FIG. 22 shows a technician interface (user interface) (interface) (UI) 340 which shows earnings history including total services provided, total earnings, and sortable earnings by date showing type of service provided, job number or request number, date service provided, and amount of income earned.

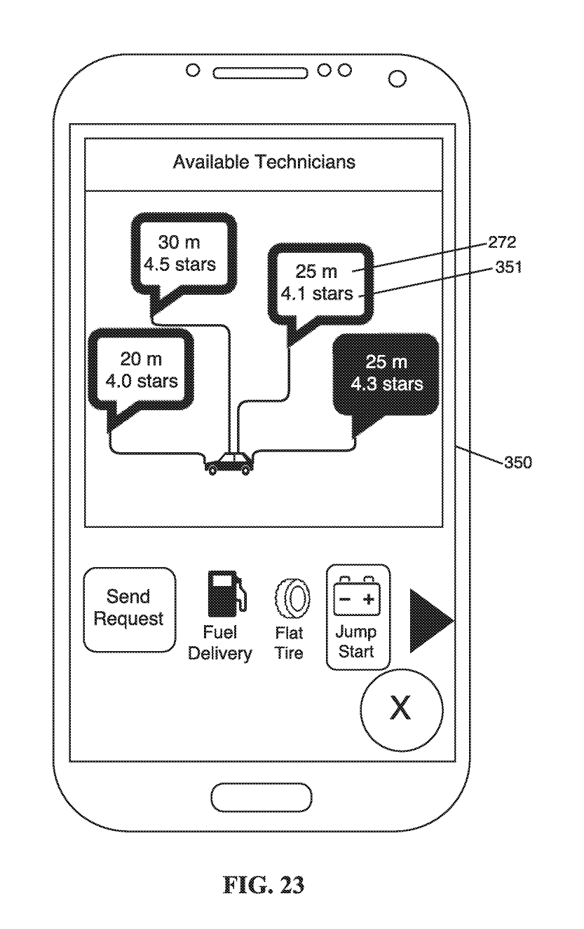

FIG. 23 shows a requester interface (user interface) (interface) (UI) 350 which may be available in some implementations of the dispatch system and methods. In this implementation after the driver has indicated he/she needs roadside assistance, at some point a map is shown indicated a number of nearby technicians, estimated ETAs 272 for each one, and a technician ranking 351 for each one, so that the user may select a desired technician based on ETA and ranking (shown by the changed color of the rightmost ETA), and the user may select through a scrollable list of services (the selection shown by example by outlining the selected service as shown) and then a request send by selecting an input such as in this example by selecting the Send Request indicator, or the user may “X” out of this screen to cancel. In this implementation in some cases the request initiated by the driver goes out to all nearby technicians and they then select their own ETA in response, and as they respond they show up on the customer's map with ETA and ranking. This method does not require a dispatcher.

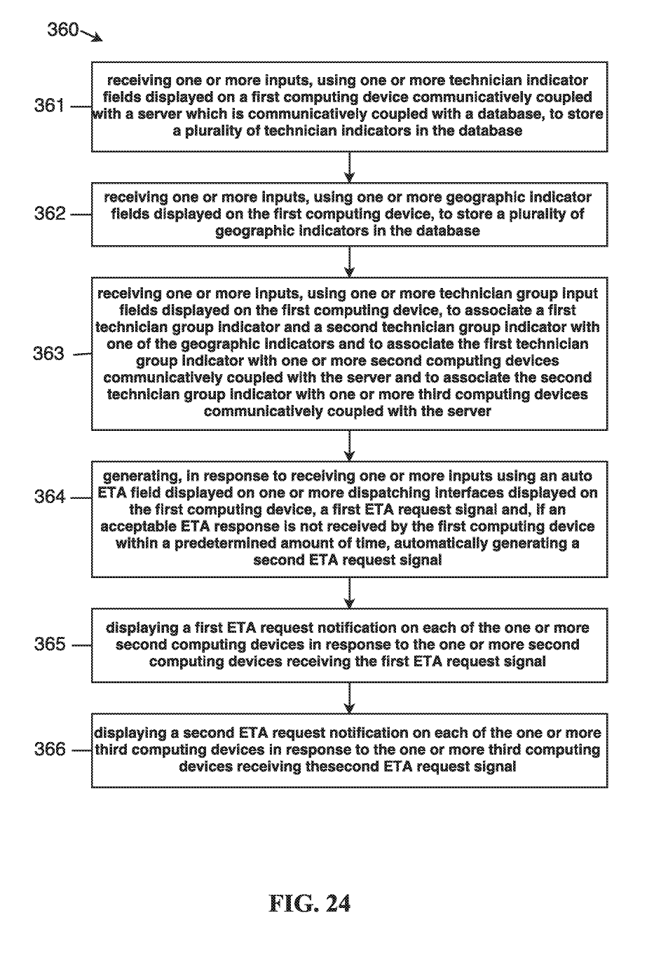

FIG. 24 shows a representative example of a dispatching method (method) 360, including receiving one or more inputs, using one or more technician indicator fields displayed on a first computing device communicatively coupled with a server which is communicatively coupled with a database, to store a plurality of technician indicators in the database (step 361); receiving one or more inputs, using one or more geographic indicator fields displayed on the first computing device, to store a plurality of geographic indicators in the database (step 362); receiving one or more inputs, using one or more technician group input fields displayed on the first computing device, to associate a first technician group indicator and a second technician group indicator with one of the geographic indicators and to associate the first technician group indicator with one or more second computing devices communicatively coupled with the server and to associate the second technician group indicator with one or more third computing devices communicatively coupled with the server (step 363); generating, in response to receiving one or more inputs using an auto ETA field displayed on one or more dispatching interfaces displayed on the first computing device, a first ETA request signal and, if an acceptable ETA response is not received by the first computing device within a predetermined amount of time, automatically generating a second ETA request signal (step 364); displaying a first ETA request notification on each of the one or more second computing devices in response to the one or more second computing devices receiving the first ETA request signal (step 365), and; displaying a second ETA request notification on each of the one or more third computing devices in response to the one or more third computing devices receiving the second ETA request signal (step 366).

Although the main example given here is for roadside assistance, this system and methods may be used for other service providers such as electricians, plumbers, etc. As indicated, in implementations the system and methods may cooperate with the insurance provider's API to further automate the process so that the dispatcher does not need to manually input any information but the request from the insurance carrier automatically triggers the auto ETA request to groups of technicians in the order set by the administrator. In such implementations the dispatcher will only be notified if there is some need for manual intervention, such as if no technician provides an ETA.

In implementations where certain examples of selecting elements and providing input are given, it is to be understood that the specific method may be altered, such as drag and drop, a touch input, a mouse click input, a manual typing input, and the like, to provide the needed input. In some implementations if an administrator tries to select a geographic indicator not within a company's territory a warning will appear and prevent the selection. In some implementations a map may be shown for each technician showing the different areas (primary, secondary, etc.) each in a different color for easy viewing. Although insurance companies are described as being able to select which company gets notified first, then second, etc., this same method and system may apply to other parties such as motor clubs, who also may make such selections on an analogous user interface.

In implementations an administrator may set a time cushion for each technician for each company. For example an administrator may select to automatically add 5 minutes to every quote for a specific company, or the administrator may select to add a certain time cushion individually for each driver for each specific service—for example technician A's ETA for a second job will automatically require an ETA that takes into account an amount of time (for example 15 minutes) that an administrator has previously indicated is how long that technician will likely take on a first job based on the technician's history and what the job is. In implementations this cushion may be set by the company instead of the administrator.

In implementations the address input on the dispatch interface may be linked to a third party mapping service or website to provide auto suggestions for addresses once the addresses have begun to be typed into the relevant field.

In some implementations the system/methods herein may be set to consider a technician's rating, for example accepting the best ETA offered from the best rated technician (for example if a setting is set to 3 out of 5 stars, the system may accept the best ETA from a technician with 3 stars or greater). The system may also be set to decline a job or cancel a job or let it time out if not acceptable ETAs are received during dispatching. In implementations in which no ETA is received from a technician (or none that are acceptable) and a default ETA is provided to the insurance company another step may be performed which may be the call going to a dispatch portal and alerting a human operator to delegate. In such an implementation, instead, the ETA request may go out again, automatically, with relaxed acceptable ETA constraints, and then again a third time, and fourth, etc., with altered ETA constraints based on prior administrator input. Along those lines, the administrator may set constraints to be relaxed for the second ETA request (to the Secondary group), and more relaxed to the third group for the third ETA request, etc. In some implementations the admin may set the system/method to, if no acceptable ETA has been received, accept the best ETA from the first set of technicians, or the best ETA from the second set of technicians, etc.

In implementations an administrator can set the system to not request an ETA from a technician already on a job, or based on distance/time away from current request and/or number of jobs in queue, etc.

In some implementations the system will request an ETA from a technician after automatically calculating the distance and time for the technician to go to prior service calls (such as a first service call and a second service call preceding the current call, etc.).

In some implementations the “first set,” “second set,” etc. of technicians (technician group indicators) may be selected on the fly by the system by: all active units within a first time frame based on estimated ETA based on GPS position and/or current job queue and/or estimated time/travel on jobs in queue; based on preset geographical indicators for specific technicians (as described with respect to FIG. 9) regardless of where those technicians are at and/or regardless of prior jobs in their queue at the time; distance (e.g., closest three units get the first request, second request goes to the next three closest units, etc.); all active units period; all active units within a time frame of acceptable estimated ETA and/or including ratings (e.g., including ETA accuracy rating, customer service rating, etc.

In some implementations invoice and other forms may be auto-filled by the system with details of the service call and spots to fill in from the mobile device of the customer and/or technician and allowing signatures and so forth.

In places where the description above refers to specific embodiments of dispatching system and related methods, one or more or many modifications may be made without departing from the spirit and scope thereof. Details of any specific embodiment/implementation described herein may, wherever possible, be applied to any other specific implementation/embodiment described herein.

What is claimed is:

1. A dispatching system, comprising:
a first computing device communicatively coupled with a server, the server communicatively coupled with a database;
one or more second computing devices communicatively coupled with the server;
one or more third computing devices communicatively coupled with the server;
one or more user interfaces displayed on a display of the first computing device and comprising:
one or more technician indicator fields configured to receive one or more inputs to store a plurality of technician indicators in the database;
one or more geographic indicator fields configured to receive one or more inputs to store a plurality of geographic indicators in the database;
one or more technician group indicator fields configured to receive one or more inputs to associate a first technician group indicator and a second technician group indicator with one of the geographic indicators and further configured to associate the first technician group indicator with the one or more second computing devices and the second technician group indicator with the one or more third computing devices;
one or more dispatching interfaces displayed on the display of the first computing device and comprising an auto ETA field configured to generate a first ETA request signal in response to receiving one or more inputs and, if an acceptable ETA is not received by the first computing device within a predetermined amount of time, configured to automatically generate a second ETA request signal;
a first ETA request notification displayed on displays of each of the one or more second computing devices in response to the one or more second computing devices receiving the first ETA request signal, and;
a second ETA request notification displayed on displays of each of the one or more third computing devices in response to the one or more third computing devices receiving the second ETA request signal.

2. The dispatching system of claim 1, wherein the first ETA request notification comprises a displayed estimated ETA and a plurality of ETA response fields, each ETA response field displaying an ETA greater than the estimated ETA and configured to generate an ETA response signal corresponding with the displayed ETA in response to receiving one or more inputs.

3. The dispatching system of claim 1, wherein the one or more technician group indicator fields are configured to receive one or more inputs to associate, in the database, the predetermined amount of time with the first technician group indicator.

4. The dispatching system of claim 1, wherein the one or more user interfaces comprise one or more continuous fields configured to receive an input to toggle whether the first ETA request notification remains displayed on the one or more second computing devices beyond the predetermined amount of time.

5. The dispatching system of claim 1, wherein the geographic indicators comprise zip codes.

6. The dispatching system of claim 1, further comprising one or more insurance provider interfaces displayed on a display of a fourth computing device communicatively coupled with the server, the one or more insurance provider interfaces comprising one or more insurance group indicator fields configured to receive one or more inputs to associate a first insurance group indicator and a second insurance group indicator with an insurance provider indicator and further configured to associate the first insurance group indicator with the one or more second computing devices and the second insurance group indicator with the one or more third computing devices.

7. The dispatching system of claim 1, further comprising one or more insurance interfaces displayed on the display of the first computing device and comprising one or more insurance input fields configured to receive one or more inputs to define one or more insurance provider indicators and to associate, through the database, each of the one or more insurance provider indicators with one or more of the geographic indicators.

8. The dispatching system of claim 1, further comprising one or more requester interfaces displayed on a display of a fifth computing device communicatively coupled with the server, the one or more requester interfaces displaying a plurality of estimated ETAs, each estimated ETA associated with one of the technician indicators through the database.

9. The dispatching system of claim 8, wherein the one or more requester interfaces further comprises a plurality of technician rankings displayed on the one or more requester interfaces, each technician ranking associated with one of the technician indicators through the database.

10. A dispatching method, comprising:
receiving one or more inputs, using one or more technician indicator fields displayed on a first computing device communicatively coupled with a server which is communicatively coupled with a database, to store a plurality of technician indicators in the database;
receiving one or more inputs, using one or more geographic indicator fields displayed on the first computing device, to store a plurality of geographic indicators in the database;
receiving one or more inputs, using one or more technician group indicator fields displayed on the first computing device, to associate a first technician group indicator and a second technician group indicator with one of the geographic indicators and to associate the first technician group indicator with one or more second computing devices communicatively coupled with the server and to associate the second technician group indicator with one or more third computing devices communicatively coupled with the server;
generating, in response to receiving one or more inputs using an auto ETA field displayed on one or more dispatching interfaces displayed on the first computing device, a first ETA request signal and, if an acceptable ETA is not received by the first computing device within a predetermined amount of time, automatically generating a second ETA request signal;
displaying a first ETA request notification on each of the one or more second computing devices in response to the one or more second computing devices receiving the first ETA request signal, and;
displaying a second ETA request notification on each of the one or more third computing devices in response to the one or more third computing devices receiving the second ETA request signal.

11. The dispatching method of claim 10, wherein displaying the first ETA request notification comprises displaying an estimated ETA and a plurality of ETA response fields, each ETA response field displaying an ETA greater than the estimated ETA and configured to generate an ETA response signal corresponding with the displayed ETA in response to receiving one or more inputs.

12. The dispatching method of claim 10, further comprising associating, in the database, the predetermined amount of time with the first technician group indicator in response to receiving one or more inputs using the one or more technician group indicator fields.

13. The dispatching method of claim 10, further comprising toggling whether the first ETA request notification remains displayed on the one or more second computing devices in response to receiving one or more inputs using one or more continuous fields displayed on the first computing device.

14. The dispatching method of claim 10, wherein the geographic indicators comprise zip codes.

15. The dispatching method of claim 10, further comprising associating a first insurance group indicator and a second insurance group indicator with an insurance provider indicator and associating the first insurance group indicator with the one or more second computing devices and associating the second insurance group indicator with the one or more third computing devices in response to receiving one or more inputs using one or more insurance group indicator fields displayed on a fourth computing device communicatively coupled with the server.

16. The dispatching method of claim 10, further comprising associating each of one or more insurance provider indicators with one or more of the geographic indicators in response to receiving one or more inputs using one or more insurance input fields displayed on the first computing device.

17. The dispatching method of claim 10, further comprising displaying one or more requester interfaces on a display of a fifth computing device communicatively coupled with the server, the one or more requester interfaces displaying a plurality of estimated ETAs, each estimated ETA associated with one of the technician indicators through the database.

18. The dispatching method of claim 17, further comprising displaying a plurality of technician rankings on the one or more requester interfaces, each technician ranking associated with one of the technician indicators through the database.

19. A dispatching method, comprising:
receiving one or more inputs, using one or more technician indicator fields displayed on a first computing device communicatively coupled with a server which is communicatively coupled with a database, to store a plurality of technician indicators in the database;
receiving one or more inputs, using one or more geographic indicator fields displayed on the first computing device, to store a plurality of geographic indicators in the database;
receiving one or more inputs, using one or more technician group indicator fields displayed on the first computing device, to associate a first technician group indicator and a second technician group indicator with one of the geographic indicators and to associate the first technician group indicator with one or more second computing devices communicatively coupled with the server and to associate the second technician group indicator with one or more third computing devices communicatively coupled with the server;
associating, in the database, a predetermined amount of time with the first technician group indicator in response to receiving one or more inputs using the one or more technician group indicator fields;
generating, in response to receiving one or more inputs using an auto ETA field displayed on one or more dispatching interfaces displayed on the first computing device, a first ETA request signal and, if an acceptable ETA is not received by the first computing device within the predetermined amount of time, automatically generating a second ETA request signal;
displaying a first ETA request notification on each of the one or more second computing devices in response to the one or more second computing devices receiving the first ETA request signal, the first ETA request notification comprising an estimated ETA and a plurality of ETA response fields, each ETA response field displaying an ETA greater than the estimated ETA and configured to generate an ETA response signal corresponding with the displayed ETA in response to receiving one or more inputs, and;
displaying a second ETA request notification on each of the one or more third computing devices in response to the one or more third computing devices receiving the second ETA request signal.

20. The dispatching method of claim 10, further comprising, in response to not receiving an acceptable ETA by the first computing device within a second predetermined amount of time, automatically sending a third ETA request signal to one or more sixth computing devices communicatively coupled with the server.
